(19) United States
(12) Patent Application Publication
(10) Pub. No.: US 2020/0061915 A1
(43) Pub. Date: Feb. 27, 2020

(54) INTERCHANGEABLE CHAMBER FOR A DEVICE AND A METHOD FOR THE ADDITIVE MANUFACTURING OF A THREE-DIMENSIONAL OBJECT

(71) Applicant: EOS GmbH Electro Optical Systems, Krailling (DE)

(72) Inventor: Sven Pawliczek, Gilching (DE)

(73) Assignee: EOS GmbH Electro Optical Systems, Krailling (DE)

(21) Appl. No.: 16/609,828

(22) PCT Filed: May 4, 2017
(86) PCT No.: PCT/EP2017/060716

§ 371 Date: Oct. 31, 2019

(51) Int. Cl. B29C 64/245; B29C 64/255; B29C 64/153

(52) U.S. Cl. CPC B29C 64/245; B33Y 10/00; B29C 64/153; B29C 64/255

(57) ABSTRACT

An interchangeable chamber for a device for manufacturing a three-dimensional object by selectively layer-wise solidifying building material, preferably powdery building material, at locations corresponding to the cross-section of the object to be manufactured in the respective layer, includes a container having an upper edge and a lower edge, a wall and a height-adjustable platform provided in the container, wherein the wall of the container has at its inside a first sealing device which adjoins the platform in a sealing position in such a way that the first sealing device and the platform cooperate for sealing the container towards the lower edge.

The present invention relates to an interchangeable chamber for a device for manufacturing a three-dimensional object by selective layer-by-layer solidification of building material.

Devices and methods of this kind are used, for example, in rapid prototyping, rapid tooling or additive manufacturing. An example of such a process is known as “selective laser sintering or laser melting”. Therein, a thin layer of a powdery building material is repeatedly applied, and the building material is selectively solidified in each layer by selective irradiation of locations corresponding to a cross-section of the object to be manufactured with a laser beam.

DE 195 14 740 C1 describes a device for manufacturing a three-dimensional object from pulverulent building material comprising a building container in which the object is built up in layers and an adjoining storage container for the pulverulent building material. The storage container has a bottom that can be displaced in a vertical direction. An applicator pushes powdery building material from the storage container to the building container and applies it there as a layer.

WO 2000/021736 A1 describes a laser sintering device in which an interchangeable container in which a height-adjustable workpiece platform is integrated as a bottom is inserted into a process chamber. After sintering the object, the interchangeable container can be removed from the building chamber in order to allow it to cool outside the sintering machine. Immediately after removing the interchangeable container, a new interchangeable container can be inserted into the laser sintering device.

The task of the present invention is to provide an alternative or improved device or method for the additive manufacturing of a three-dimensional object by layerwise application and selective solidification of a building material using an interchangeable chamber which has at least one height-adjustable platform.

This object is accomplished by an interchangeable chamber according to claim 1 or 12, a device according to claim 13 and a method according to claim 15. Further developments of the invention are indicated in the dependent claims, respectively. The method may also be further developed by the features of the devices described below or in the dependent claims or vice versa, or the features of the devices may also be used for mutual further development.

The interchangeable chamber according to the invention is destined for being inserted into a device for producing a three-dimensional object by selective layerwise solidification of building material, preferably a powdery building material, at locations corresponding to the cross-section of the object to be manufactured in the respective layer. The interchangeable chamber comprises a container having an upper edge and a lower edge, a wall and a height-adjustable platform provided in the container. The wall of the container has on its inside a first sealing device connecting to the platform in a sealing position in such a way that the first sealing device and the platform cooperate to seal the container towards the lower edge. With such an interchangeable chamber, it is for example possible to reliably seal the container at the bottom so that the interchangeable chamber can be handled and transported outside the device without the operator coming into contact with the powder leaving the interchangeable chamber and without the environment being contaminated with powder.

Preferably, the platform has a second sealing device which seals against an inside of the wall of the container and/or against the first sealing device. This may, for example, improve the sealing effect.

Preferably, the first sealing device is designed in such a way that, when the interchangeable chamber is positioned as intended, building material impinging on the first sealing device is conveyed further substantially towards the lower edge of the interchangeable chamber. This may, for example, prevent the sealing effect from being impaired by building material remaining on the sealing device.

Preferably, the first sealing device has at least one surface section which protrudes into the inside of the container, wherein the at least one surface section preferably is directed obliquely in the direction of the lower edge of the interchangeable chamber. This allows, for example, building material impinging on the first sealing device to slip on the surface section towards the bottom edge of the interchangeable chamber.

Preferably, the first sealing device is arranged substantially on the inside of the wall of the container so as to extend circumferentially therein. This allows, for example, a circumferential sealing to be achieved.

Preferably, the first sealing device comprises a sheet metal and/or metal molded part and/or a part consisting of an elastic polymer, preferably silicone rubber, inserted into the wall of the container. This makes it possible, for example, to implement the seal by means of a part that is easy to manufacture.

Preferably, the first sealing device is arranged closer to the lower edge than to the upper edge, preferably at or near the lower edge, wherein preferably the sealing position is a position of the platform in a lower region of the container. Thus, for example, it is possible to use as large a portion of the container as possible.

Preferably, the sealing position is a position of the platform in the container in which the platform can be coupled to and/or uncoupled from a carrier device provided in the device. In this way, for example, the platform can be coupled to the carrier device and/or uncoupled from this device in a sealed state.

Preferably, the first sealing device on the one hand and the platform and/or the second sealing device on the other hand cooperate in the sealing position in such a way that building material cannot pass there between, preferably the container is closed in a gas-tight manner towards the bottom. This allows, for example, an advantageous sealing of the container at the bottom.

Preferably, the second sealing device is arranged on the side of the platform facing the lower edge of the container and/or wherein the second sealing device is arranged on the platform at a distance from the inside of the wall of the container. This allows, for example, the second sealing device to cooperate well with the first.

Preferably, the second sealing device comprises an elastic seal, preferably a seal made of rubber or silicone foam. This can, for example, improve the sealing effect.

Another interchangeable chamber according to the invention is destined for being inserted into a device for manufacturing a three-dimensional object by selective layerwise solidification of building material, preferably powdery building material, at locations corresponding to the cross-section of the object to be manufactured in the respective layer. The interchangeable chamber comprises a container having an upper edge and a lower edge, a wall and a platform provided in the container, and a deflecting device which is provided on the inside of the wall of the container and is designed in such a way that, when the interchangeable chamber is positioned in accordance with its intended purpose, building material impinging on the deflecting device is conveyed further towards the lower edge. Preferably, the interchangeable chamber formed as described above, and the deflecting means is the first sealing means. This makes it possible, for example, to deviate powder trickling down on the inside of the container wall in a suitable form, for example towards a collecting tray provided in the device.

The device according to the invention serves for manufacturing a three-dimensional object by selectively solidifying building material layer by layer at locations corresponding to the cross section of the object to be manufactured in the respective layer. The device comprises an interchangeable chamber according to the invention which can be removed from the device and inserted into it. By means of such a device it is possible, for example, to create objects in quick succession. Furthermore, the effects described for the interchangeable chamber can be achieved.

Preferably, the device comprises a collecting device and/or a suction device for receiving building material leaking from the interchangeable chamber. This can, for example, prevent contamination of the device with building material.

The method according to the invention serves for manufacturing a three-dimensional object by selectively layer-by-layer solidifying building material at locations corresponding to the cross-section of the object to be manufactured in the respective layer using an interchangeable chamber according to the invention, For the insertion and/or withdrawal of the interchangeable chamber into or from the device, the platform is brought into the sealing position in the container, and/or during the manufacturing process of the three-dimensional object, the platform is not or at least only for a short time in the sealing position in the container. In this way, for example, the effects of the interchangeable chamber described above can be achieved in the production of a three-dimensional object.

Further features and purposes of the invention result from the description of implementation examples on the basis of the attached figures.

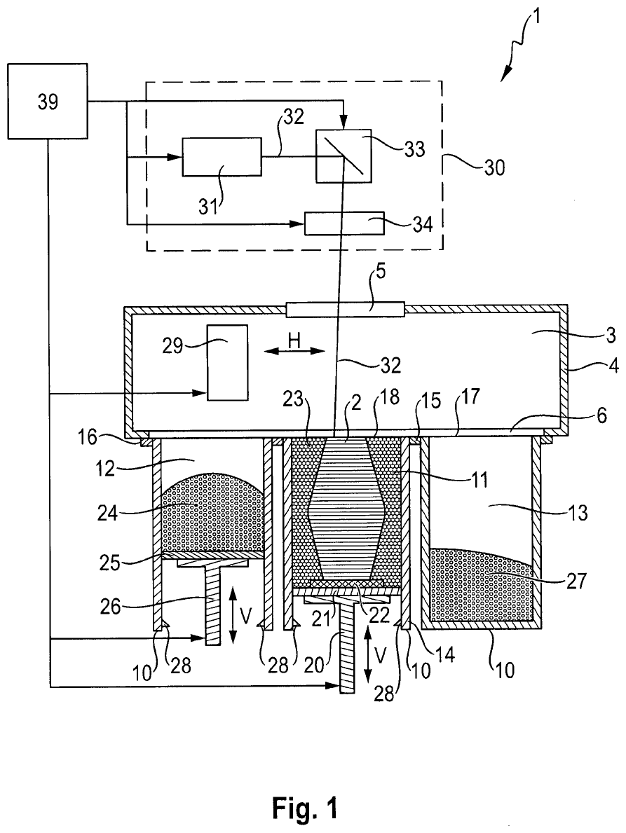

FIG. 1 is a schematic view, partially depicted in section, of a device for the additive manufacturing of a three-dimensional object according to an embodiment of the present invention.

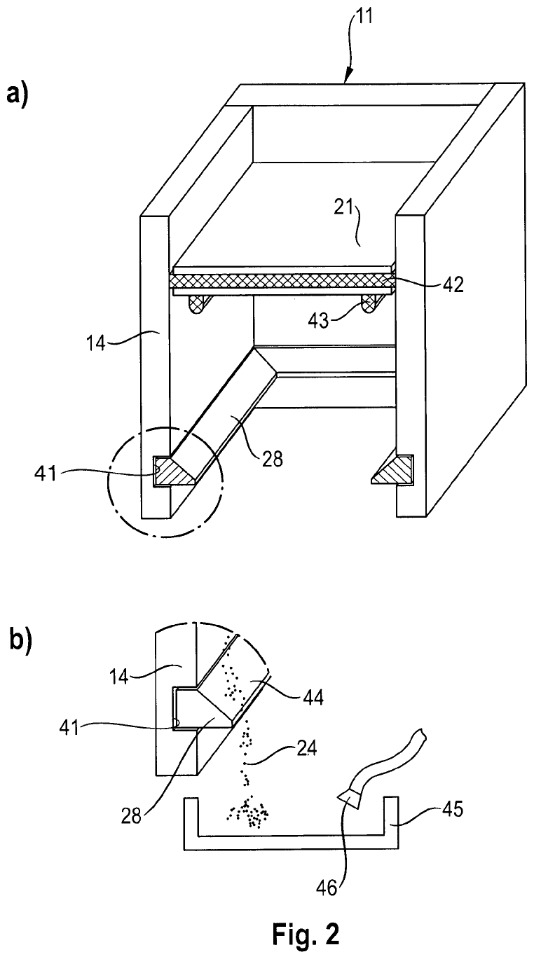

FIG. 2a schematically shows sealing devices in a container included in the device shown in FIG. 1, here in perspective cross-sectional view.

FIG. 2b schematically shows a functionality of a sealing device during operation of the device shown in FIG. 1 in a detailed view from FIG. 2a.

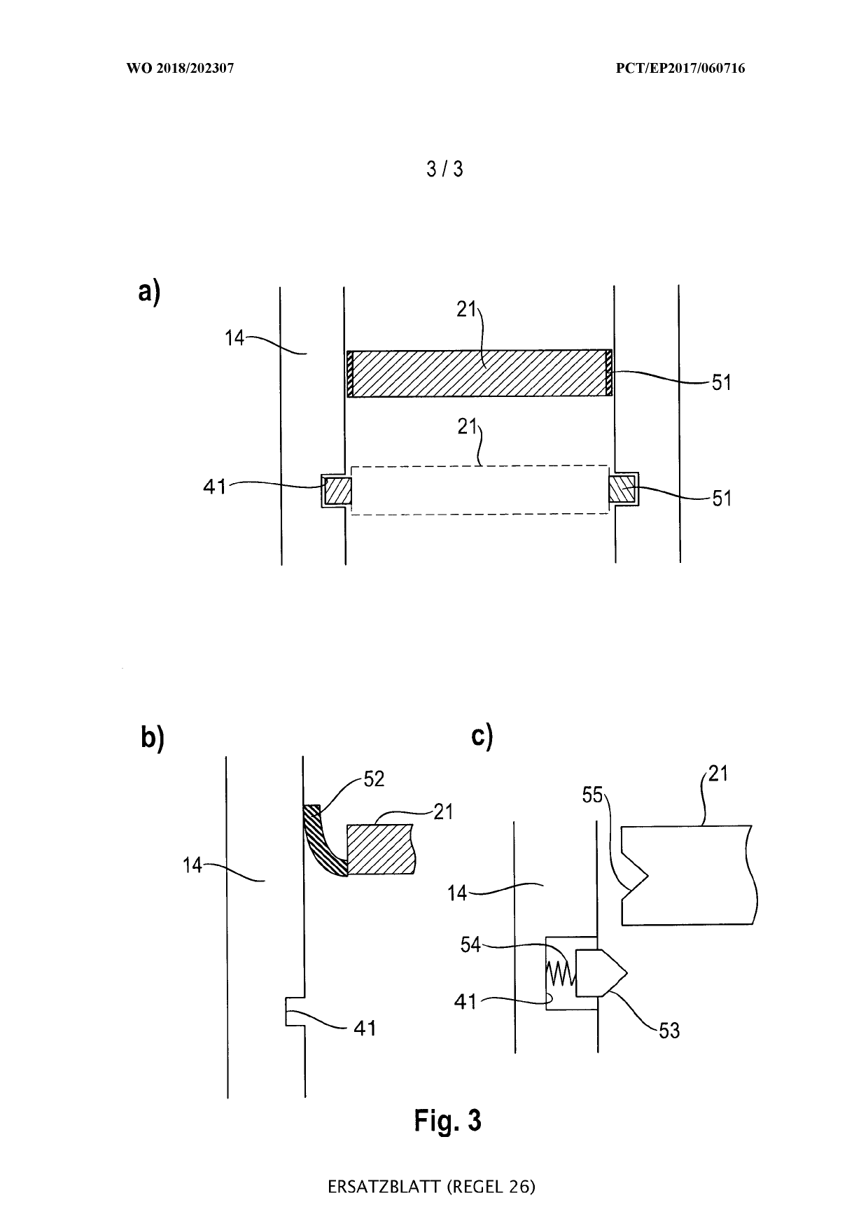

FIGS. 3a to 3c schematically show, in sectional views, various configurations of sealing devices which can be used in the context of the invention.

In the following, an embodiment of the present invention is described with reference to FIG. 1. The device shown in FIG. 1 is a laser sintering or laser melting device 1. To build an object 2, it contains a process chamber 3 having a chamber wall 4. On the upper side of the process chamber 3, a coupling window 5 is arranged, and on the lower side of the process chamber 3, an opening 6 is formed in the chamber wall 4.

An interchangeable chamber 10, which can be inserted into and removed from the device 1, is docked to the process chamber 3 from below. The interchangeable chamber 10 contains three containers which are arranged vertically when the interchangeable chamber 10 is positioned as intended, i.e. in the position in which manufacturing of the object 2 is carried out, and they are therefore also referred to as shafts. Among these containers are a building container 11, a storage container 12 and an overflow container 13.

The containers 11, 12, 13 have container walls 14, which can be arranged separately from each other, but adjacent containers may also have a common container wall 14. If containers 11, 12, 13 are formed with separate container walls 14, one or more working plates 15 may be arranged between them. One or more flanges 16 are arranged on the side of the interchangeable chamber 10 for docking the interchangeable chamber 10 to the process chamber 3.

The containers 11, 12, 13 are open at the top. A working plane 17 is defined by the top edge of the building container 11, whereby the area of the working plane 17 within the opening of the building container 11, which can be used to manufacture the object 2, is referred to as a build area 18. Preferably, the interchangeable chamber 10 is formed in such a way that the upper edges of the storage tank 12 and the overflow tank 13 are also located in the working plane 17, and preferably also the upper surface(s) of the working plate(s) 15 and/or of the flange or flanges. When the interchangeable chamber is positioned as intended, the working plane 17 is essentially horizontal.

The building container 11 is used for the layer-wise building of the three-dimensional object. In the building container 11, a support 20 movable in a vertical direction V is arranged, on which a base plate 21 is attached, which closes off the building container 11 downwards and thus forms its bottom. The base plate 21 may be a plate formed separately from the support 20 which is attached to the support 20, or it may be formed integrally with the support 20. Depending on the powder and the process used, a building platform 22 may also be placed on the base plate 21 as a building base on which the object 2 is built. The object 2, however, may also be built on the base plate 21 itself which then serves as a building support. In FIG. 1, the object 2 to be formed in the building container 11 on the building platform 22 below the working level 17 is shown in an intermediate state with several solidified layers, surrounded by unsolidified building material 23.

The storage container 12 serves to accommodate a powdery building material 24 which can be solidified by electromagnetic radiation. It is formed as a dosing shaft in which a platform 25, which forms the base of the storage container 12, rests on a post 26, which can be moved in the vertical direction V.

The overflow container 13 is used to receive excess powder 27. It is arranged on the side of the building container 11 opposite to the storage container 12.

A sealing device 28 is arranged at the lower part of the building container 11 and/or the storage container 12.

Further, the laser sintering device 1 comprises an applicator 29 movable in a horizontal direction H for applying the building material 15 within the build area 18. Preferably, the applicator 29 extends transversely to its direction of movement H across the entire area to be coated.

The laser sintering device 1 further comprises an irradiation device 30 with a laser 31 which generates a laser beam 32 which is deflected by a deflection device 33 and focused by a focusing device 34 via the coupling window 5 at the top of the process chamber 3 onto the working plane 17.

Finally, the laser sintering device 1 comprises a control unit 39 which controls the individual components of the device 1 in a coordinated manner for carrying out the building process. Alternatively, the control unit may also be arranged partially or completely outside the device. The control unit may include a CPU the operation of which is controlled by a computer program (software). The computer program may be stored separately from the device on a storage medium from which it can be loaded into the device, in particular into the control unit.

Before manufacturing the object 2 by means of device 1, the storage container 12 is filled with powdery building material 24. Then the interchangeable chamber 10 prepared in this way is docked to the process chamber 3. During operation, the carrier 20 is then lowered by a height corresponding to the desired layer thickness for the application of a powder layer. The applicator 19 first moves to the side of the storage container 12 facing away from the building container 11 (on the left in the drawing). Then, the bottom 25 of the storage container 12 is raised by means of a post 26 driven by a lifting device (not shown in the Fig.) until the surface of the powder supply protrudes upwards beyond the lower edge of the applicator 19. As the applicator travels across the build area 18 (to the right in the drawing), it takes this powdery building material 24 protruding beyond its lower edge along, moves it to the build area 18 onto the building base or a pre-existing powder layer and pulls it out to form a powder layer. The application is performed at least across the entire cross-section of the object 2 to be manufactured, preferably across the entire build area 18, i.e. the area delimited by the container wall 14 of the build container 11. On the side of build area 8 opposite the storage container 12, excess powder 27 falls into the overflow container 13.

The cross-section of the object 2 to be manufactured is then scanned by the laser beam 32 so that the powdery building material 24 is solidified at the locations corresponding to the cross-section of the object 2 to be manufactured. In this process, the powder grains are partially or completely melted at these locations by means of the energy introduced by the radiation, so that after cooling they are connected to each other in the form of a solid. These steps are repeated until object 2 is completed. The interchangeable chamber 10 is then undocked from the process chamber 3 and removed from the device 1. If another object 2 is to be manufactured, an appropriately prepared further interchangeable chamber 10 is inserted into the process chamber 3, and the building of the next object 2 can start.

The interchangeable chamber 10 removed from the device 1 can cool down outside the device 1. Afterwards, the manufactured object 2 can be extracted from the interchangeable chamber 10.

The height-adjustable platforms, i.e. the base plate 21 in the building container 11 and the base 25 of the storage container 12, are sealed against the respective container wall 14 so that during operation of the device 1, leakage of the powdery build-up material 24 is avoided as far as possible. Since platform 21, 25 has to remain movable within the respective container 11, 12, the sealing effect of this sealing is limited. A small amount of the powder may therefore trickle through the seal between the container wall 14 and the platform 21, 25 and fall downwards into the device where it can purposefully be collected and suctioned off.

Powder may also trickle through the lateral seal of platform 21, 25 when the interchangeable chamber 10 is removed from device 1 and during its transport outside the device 1 and lead to contamination of the environment. To prevent this, the sealing device 28 is provided in the building container 11 and/or the storage container 12.

After the end of a building job, the respective platform 21, 25 is moved downwards so far that it sits on the sealing device 28. The sealing device 28 and the platform 21, 25 work together to close the container 11, 12 towards its lower edge. This reliably seals the space between the platform 21, 25 and the container wall 14, so that powder is prevented from escaping. Preferably, the container 11, 12 is also sealed gas-tight at the bottom thereby.

This position of the platform 21, 25, in which it interacts with the sealing device 28, is designated as a sealing position. The sealing position is preferably also the position of the platform 21, 25 in the container 11, 12, in which it can be coupled to and/or uncoupled from a carrier device 20, 26 provided in the device.

FIG. 2a schematically shows a perspective cross-sectional view of a container included in the interchangeable chamber 10. As an example, the building container 11 is shown, but the explanations also apply to the storage container 12. The holder 10 for the platform 11 has been omitted for better clarity.

As can be seen from FIG. 2a, the (first) sealing device 28 (here referred to as “first sealing device”) is arranged circumferentially near the lower edge of the container 11 on the inside of the container wall 14, so that platform 21 can rest on it with its entire circumference. Preferably the sealing device 28, as shown in FIG. 2a, is inserted into a groove 41 in the container wall 14. It may, for example, comprise a sheet metal and/or a metal molded part and/or a part made of silicone rubber.

FIG. 2a shows other sealing devices attached to the platform 21. A sealing device 42 running around the outside of platform 21 serves to seal the space between the platform 21 and the container wall 14 during the operation of the device 1, i.e. also during the vertical movement of the platform 21.

A sealing device 43 (here referred to as “second sealing device 43”) located below the platform 21 (here referred to as “second sealing device”) is arranged circumferentially in the vicinity of the edge of the platform 21 in such a way that it rests on the first sealing device 28 and cooperates with it when the platform 21 is in the sealing position. It may be spaced from the inside of the container wall 14 as long as a reliable seal is ensured in the sealing position in cooperation with the sealing device 28.

The sealing devices 42, 43 preferably comprise an elastic seal. This means that the sealing may be made of an elastic material, such as rubber or silicone foam, or it may be formed by its design in such a way that it is subjected to a deflection under a force, for example in the form of a leaf spring.

FIG. 2b shows a portion of the container wall 14 indicated in FIG. 2a by a dotted circle during operation of the device 1. Here powder 24 passing between the container wall 14 and the platform 21 may trickle downwards along the container wall 14 and hit the sealing device 28. However, the latter is designed in such a way that the powder 24 does not remain on it but is conveyed further in the direction of the lower edge. The sealing device 28 thus also acts as a deflecting device for the powder 24 hitting it.

For this purpose, the sealing device 28 has a bevel 44, i.e. a surface section that protrudes into the inside of the container and points obliquely towards the lower edge of the interchangeable chamber. This bevel is formed sufficiently steep so that the powder 24 trickles further out of the interchangeable chamber 10 and comes to rest under the interchangeable chamber 10 in the device 1 in a collecting tray 45 and/or is suctioned off by a suction device 46. This prevents powder 24 from remaining on the sealing surface between the sealing device 28 and the platform 21, which would impede an effective sealing fit.

FIG. 3 shows further possibilities for the end seal between the container wall 14 and the platform 21.

FIG. 3a shows a sealing device 51 which is arranged on the outer circumference of platform 21 and is formed elastically. As soon as the platform 21 reaches the groove 41 during lowering, the sealing device 51 moves forward into the groove 41 and thereby achieves an end seal between the container wall 14 and the platform 21.

The sealing device 52 shown in FIG. 3b is formed as an elastic sealing lip which is also arranged on the outer circumference of the platform 21. As soon as the platform 21 reaches the groove 41 during lowering, the sealing lip 52 flaps into the groove and thereby achieves an end seal between the container wall 14 and the platform 21.

The sealing device shown in FIG. 3c has a wedge-shaped sealing element 53 elastically mounted in the groove 41, for example with a spring 54. A wedge-shaped groove 55 is formed on the outer circumference of the platform 21. As soon as the platform 21 reaches the groove 41 during lowering, the wedge-shaped sealing element 53 moves forward into the wedge-shaped groove 55 and thereby achieves an end seal between the container wall 14 and the platform 21.

The sealing device 28 is not restricted to the shapes described above. It can have any shape which is suitable for cooperating with the height-adjustable platform 21, 25 to close the container 11, 12 downwards. It can, for example, also be formed merely by a step in the container wall 14 or by a position on the container wall 14 manufactured (e.g. ground) with a sufficient degree of precision (e.g. with a specified tolerance) in order to seal against the height-adjustable platform 21, 25.

In the laser sintering device 1 described above, the height-adjustable platforms 21, 25 for inserting and/or removing the interchangeable chamber 10 into the device 1 or out of it are brought into their sealing position. This makes it possible to handle and transport the interchangeable chamber 10 outside the device 1 without the operator coming into contact with powder leaving the interchangeable chamber 10 and without the environment being contaminated with powder. The sealing device 28 also acts as an end stop for the height-adjustable platforms 21, 25 and prevents them from falling out downwards.

During the manufacturing process of the three-dimensional object 2, however, the platforms 21, 25 are moved upwards, and they therefore are not or at least only briefly in the sealing position. In this state, however, powder escaping from the interchangeable chamber 10 can easily be collected in a collecting device or suctioned off by means of a suction device.

While the interchangeable chamber described above contains three containers, two of which have a height-adjustable platform, the present invention can also be applied to interchangeable chambers with more or less than three containers and with more or less than two height-adjustable platforms, in particular also to a single container with a height-adjustable platform.

Although the present invention has been described with reference to a laser sintering or laser melting device, it is not restricted to laser sintering or laser melting. It may be applied to any method for the additive manufacturing of a three-dimensional object by applying and selectively solidifying a building material layer-by-layer.

The irradiation device may comprise for example one or more gas or solid state lasers or any other type of laser such as laser diodes, especially VCSEL (Vertical Cavity Surface Emitting Laser) or VECSEL (Vertical External Cavity Surface Emitting Laser), or an array of those lasers. In general, any device by which energy in form of wave or particle radiation can be selectively applied onto a layer of the building material may be used as an irradiation device. Instead of a laser, another light source, an electron beam or any other energy or radiation source which is suitable for solidifying the building material may be used, for example. Instead of the deflection of a beam, irradiation by means of a moveable row irradiator may be used. The invention may also be applied to selective mask sintering, in which a mask and an extended light source are used, or to high-speed sintering (HSS) wherein a material that increases (absorption sintering) or reduces (inhibition sintering) the absorption of the radiation at the corresponding positions may selectively be applied onto the building material, whereupon irradiation is unselectively carried out by a large-area irradiation or by means of a moveable row irradiator.

Instead of the introduction of energy, the selective solidification of the applied building material can, for example, also be achieved by other methods such as 3D printing, for example by means of the application of an adhesive. In this example, the solidification direction would be the direction in which the adhesive is applied to the powder surface. In general, the invention relates to the additive manufacturing of an object by means of a layer-by-layer application and selective solidification of a building material not depending on the manner in which the building material is solidified.

Various types of powder may be used as the building material, in particular metal powders, plastic powders, ceramic powders, sand, filled or mixed powders. Therein, powder may also be provided in the form of a suspension. Instead of powder, other suitable materials may also be used as a building material.

1. Interchangeable chamber for a device for producing a three-dimensional object by selective layerwise solidification of building material at locations corresponding to the cross-section of the object to be manufactured in the respective layer, the interchangeable chamber comprising
a container having an upper edge and a lower edge, a wall and a height-adjustable platform provided in the container, wherein
the wall of the container has on its inside a first sealing device 7 connecting to the platform in a sealing position in such a way that the first sealing device and the platform cooperate to seal the container towards the lower edge.

2. Interchangeable chamber according to claim 1, wherein the platform has a second sealing device which seals against an inside of the wall of the container and/or against the first sealing device.

3. Interchangeable chamber according to claim 1, wherein the first sealing device is designed in such a way that, when the interchangeable chamber is positioned as intended, building material impinging on the first sealing device is conveyed further substantially towards the lower edge of the interchangeable chamber.

4. Interchangeable chamber according to claim 1, wherein the first sealing device has at least one surface section which protrudes into the inside of the container.

5. Interchangeable chamber according to claim 1, wherein the first sealing device is arranged substantially on the inside of the wall of the container so as to extend circumferentially therein.

6. Interchangeable chamber according to claim 1, wherein the first sealing device comprises a sheet metal and/or metal molded part and/or a part consisting of an elastic polymer inserted into the wall of the container.

7. Interchangeable chamber according to claim 1, wherein the first sealing device is arranged closer to the lower edge than to the upper edge.

8. Interchangeable chamber according to claim 1, wherein the sealing position is a position of the platform in the container in which the platform can be coupled to and/or uncoupled from a carrier device provided in the device.

9. Interchangeable chamber according to claim 1, wherein the first sealing device on the one hand and the platform and/or the second sealing device on the other hand cooperate in the sealing position in such a way that building material cannot pass there between.

10. Interchangeable chamber according to claim 1, wherein the second sealing device is arranged on the side of the platform facing the lower edge of the container and/or wherein the second sealing device is arranged on the platform at a distance from the inside of the wall of the container.

11. Interchangeable chamber according to claim 1, wherein the second sealing device comprises an elastic seal.

12. Interchangeable chamber for a device for manufacturing a three-dimensional object by selective layerwise solidification of building material, at locations corresponding to the cross-section of the object to be manufactured in the respective layer, the interchangeable chamber comprising:
a container having an upper edge and a lower edge, a wall and a platform provided in the container, and
a deflecting device which is provided on the inside of the wall of the container and is designed in such a way that, when the interchangeable chamber is positioned in accordance with its intended purpose, building material impinging on the deflecting device is conveyed further towards the lower edge
the deflecting means is the first sealing means.

13. Device for manufacturing a three-dimensional object by selectively solidifying building material layer by layer at locations corresponding to the cross section of the object to be manufactured in the respective layer, comprising
an interchangeable chamber according to claim 1, wherein the interchangeable chamber can be removed from the device and inserted into it.

14. Device according to claim 13, wherein the device comprises a collecting device and/or a suction device for receiving building material leaking from the interchangeable chamber.

15. A method for manufacturing a three-dimensional object by selectively layer-by-layer solidifying building material at locations corresponding to the cross-section of the object to be manufactured in the respective layer using an interchangeable chamber according to claim 1, wherein
for the insertion and/or withdrawal of the interchangeable chamber into or from the device the platform is brought into the sealing position in the container, and/or wherein
during the manufacturing process of the three-dimensional object, the platform is not or at least only for a short time in the sealing position in the container.

16. Interchangeable chamber according to claim 1, wherein the building material is a powdery building material.

17. Interchangeable chamber according to claim 4, wherein the at least one surface section is directed obliquely in the direction of the lower edge of the interchangeable chamber.

18. Interchangeable chamber according to claim 6, wherein the first sealing device comprises a part consisting of silicone rubber.

19. Interchangeable chamber according to claim 7, wherein the first sealing device is arranged at or near the lower edge.

20. Interchangeable chamber according to claim 7, wherein the sealing position is a position of the platform in a lower region of the container.

21. Interchangeable chamber according to claim 9, wherein the container is closed in a gas-tight manner towards the bottom.

22. Interchangeable chamber according to claim 11, wherein the second sealing device comprises a seal made of rubber or silicone foam.

23. Interchangeable chamber according to claim 12, wherein
the interchangeable chamber an interchangeable chamber for a device for producing a three-dimensional object by selective layerwise solidification of building material at locations corresponding to the cross-section of the object to be manufactured in the respective layer, the interchangeable chamber comprising
a container having an upper edge and a lower edge, a wall- and a height-adjustable platform provided in the container, wherein
the wall of the container has on its inside a first sealing device connecting to the platform in a sealing position in such a way that the first sealing device and the platform cooperate to seal the container towards the lower edge, and
the deflecting means is the first sealing means.
